(19) United States
(12) Patent Application Publication
(10) Pub. No.: US 2011/0241555 A1
(43) Pub. Date: Oct. 6, 2011

(54) Changeable LED finials

(76) Inventors: Shih-Ming Lin, Chang Hua (TW); Hung-Chi Lin, Chang Hua (TW)

(21) Appl. No.: 12/798,304

(22) Filed: Apr. 1, 2010

(51) Int. Cl. A47H 1/02; H05B 39/06

(52) U.S. Cl. 315/159

(57) ABSTRACT

A battery-powered, low-power-consumption LED lighted curtain rod ornamental finial with an automatic light sensitive switch. The LED lights will require very small amounts of power, allowing very long battery life. The use of LED lights eliminates the need for a power cord connected to a household electrical outlet. The automatic switch will turn the LED lights on and off according to a predetermined setting, thereby enhancing the efficient use of energy, low power consumption, and increased battery life. In a preferred embodiment, the LED lights are also controlled by a manual, remote controlled power switch, so that a user may turn off the lighting system.

### FIELD OF THE INVENTION

The present invention relates to curtain rod finials with low-power, battery operated LED illumination and automatic light sensing switch capability.

### BACKGROUND OF THE INVENTION

U.S. Pat. No. 5,412,553 to Wojski discloses lighted curtain hardware that relied on power from a 110V household electrical outlet. Wojski also disclosed the use of a transformer to step down this voltage with a transformer (76) to lower the power supplied to the light. However, Wojski still relied on power from a household electrical outlet and an electrical cord running from the outlet up to the curtain hardware. The power cord is unattractive, especially when used with a curtain rod, because the cord must extend from near the floor, where conventional electrical outlets are located, all the way up to the rod, near the ceiling. It is very difficult to obscure the electrical cord, especially where the cord's color contrasts with that of the window's decor. Also, the use of a household electrical outlet and a transformer fails to eliminate the safety hazard created by the high voltage provided by the household power source. Another disadvantage of Wojski is that the lights must be turned on and off manually, which is an inconvenience to the user. Moreover, conventional incandescent lights, such as those disclosed in Wojski, are available in only a limited range of colors. Moreover, to change the color of incandescent lights, it is usually necessary to change the bulb, or interpose a filter, or change the shade, in this case, the finial.

Wojski references two patents for illuminated batons, U.S. Pat. Nos. 2,681,979 to Manoloff and 3,384,741 to Bice et al., which disclosed batteries used to power a small light at the end of a baton. These battery-powered lights have the disadvantage of having a very short life span, because the batteries quickly drain. Also, conventional incandescent bulbs have short lifespans, requiring periodic replacement. These baton patents are not analogous art to the present field of illuminated curtain rod finials, since batons are an entirely different field of endeavor and the problems considered by baton art, such as Manoloff and Bice, are very different. For example, the Manoloff patent identifies weight and the moment of inertia as baton-related problems his invention is directed to solving. See Manoloff, column 1, lines 4 through 23 and 29 through 34. In the field of curtain rod finials, weight and inertia are not concerns, since the curtain rods are hung from building walls and are stationary. Bice et al. identify safety (compared to fire wands) and balance as problems their invention is directed to solving. See Bice et al., column 1, lines 24 through 48. Illuminated curtain rod finials do not have the fire problem experienced by fire wands, and balance is not a curtain rod finial problem, since curtain rods are stationary objects hung from walls. Both Manoloff and Bice et al. also cite damage to electrical circuitry as a problem their baton inventions are directed to solving by providing more rugged structures. See Manoloff, column 1, lines 31-32, and Bice et al., column 1, lines 49 through 53. Again, because illuminated curtain rod finials are stationary objects, this is not a problem involved in the field of the present invention. Even if these baton patents are considered, they do not address the problems or benefits of the present invention. In the field of home decor, consumers are unwilling to accept the short battery and bulb life of the devices disclosed in Manoloff and Bice et al. For example, if batteries were used to illuminate a curtain rod end in a manner similar to the illuminated batons of Manoloff and Bice et al., it would be necessary to replace the batteries on a weekly or even more frequent basis. Similarly, incandescent bulbs have short life spans, especially when turned on for long periods of time, which is the case with illuminated curtain rod finials. Consumers will not accept the inconvenience of short battery or bulb life. For this reason, neither Manoloff nor Bice et al. provide a workable source of illumination for a curtain rod finial.

### SUMMARY OF INVENTION

The present invention provides a system for illuminating curtain rod finials that avoids the use of a household electrical power source, eliminates electrical cords, eliminates manual switching, provides energy efficient and long-lasting illumination, and allows for simple changes to light color and finial ornamentation.

The present invention employs battery-powered LED lights and a light sensor. LED lights use very little power and can operate on battery power for very long periods. In addition, a light sensor can turn the LED lights on when natural light dims and off during daylight in order further to conserve battery life. A preferred embodiment of the present invention also provides a remote control manual on/off switch, so that the lights can be turned on or off at the owner's pleasure. The on/off switch can override the light sensor switch to conserve battery life when house is empt for some days.

The present invention provides a system that allows ornamented finials to be changed easily by the user. This permits many decorative options. For example, in Winter, illuminated finials with seasonal themes and colors can be used. Then, in Spring, the finials can be changed to suit new season or decorative theme of the home. The present system allows the user to keep the basic curtain rod even when the home's decor is changed, by changing the finial to suit the new decor.

The present invention also takes advantage of the multi-colored light that LEDs are capable of providing, thereby allowing a user to change the light color emitted by the LED.

### BRIEF DESCRIPTION OF DRAWINGS

FIG. 1 is a cross-section view of a curtain rod and finial of the present invention.

FIGS. 2A through 2C show how the parts of the curtain rod, LED unit and finial connect to each other, as well as the location for the batteries.

### DETAILED DESCRIPTION OF PREFERRED EMBODIMENTS

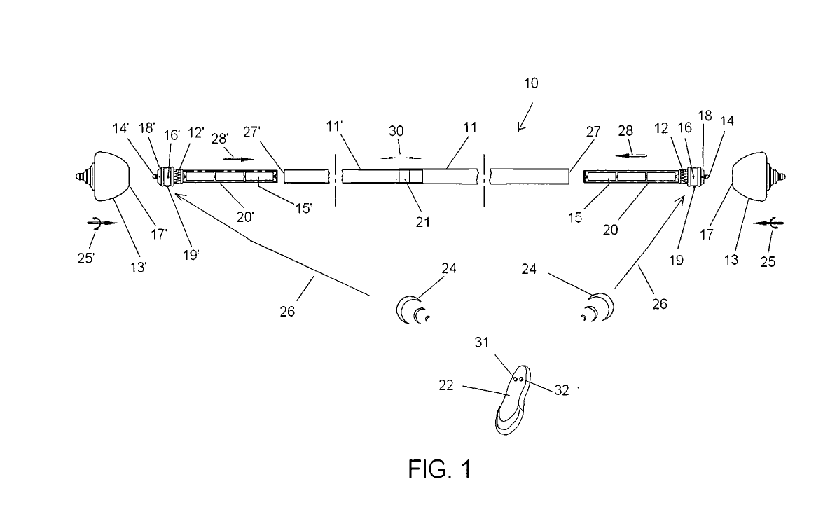

FIG. 1 shows a cross section of the LED illuminated curtain rod finial system 10 of the present invention. The curtain rod is formed of right and left halves, 11 and 11′. The left curtain rod 11′ has a slightly smaller diameter than the right curtain rod 11, so that the left rod 11′ is slidably received in the right curtain rod 11, as shown by the arrows 30 at joint 21. In this way, the length of the combined curtain rod, 11 and 11′, can be adjusted to fit many different sized windows and openings. Persons familiar with the art of curtain rods will appreciate that many arrangements are available to secure two halves of an adjustable curtain rod.

At each of the ends, 27 and 27′, of the curtain rods, 11 and 11′, are LED illuminated finial cartridges, 20 and 20′. The cartridges, 20 and 20′, are sized to fit within the ends, 27 and 27′. Arrows 28 and 28′ show how the cartridges, 20 and 20′, are directed in the curtain rod ends, 27 and 27′. Friction surfaces, 12 and 12′, on the cartridges, 20 and 20′, engage the inside surfaces of the curtain rod ends, 27 and 27′, to hold the cartridges, 20 and 20′, in place. Alternatively, surfaces 12 and 12′ could have male threads and the inner surfaces of the curtain ends, 27 and 27′, could have complimentary female threads. Persons of skill in the art will appreciate that many different arrangements are possible to secure the cartridges, 20 and 20′, to the ends, 27 and 27′, of the curtain rods, 11 and 11′.

As shown in FIG. 1, decorative finials, 13 and 13′, are attached to the ends of the LED illuminated finial cartridges, 20 and 20′. It is conventional that finials are matched pairs, as shown, although this is not necessary and different finials can be combined.

In FIG. 1, the curtain rod is divided into right and left halves, 11 and 11′. As shown in this preferred embodiment, the parts on the left half are identical to those on the right, and the corresponding numbers are the same, except those on the left include an apostrophe. For the following description, the right side will be discussed and the description applies as well to the left side.

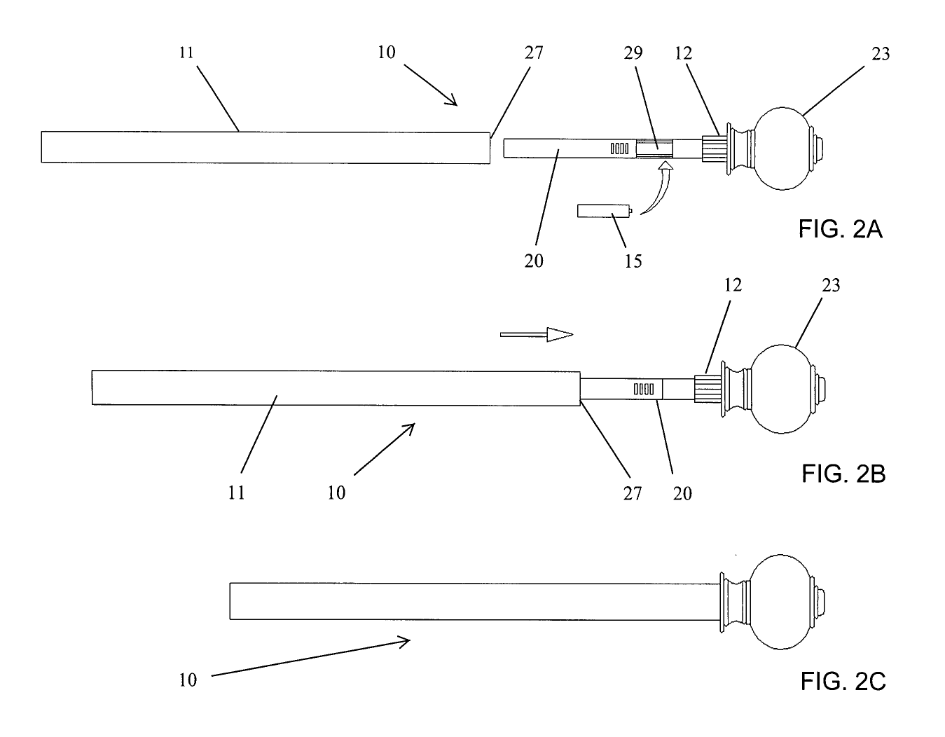

The finial 13 shown in FIG. 1 is substantially transparent, allowing light from within to illuminate it. Decorative transparent finials can be made in an infinite variety of styles and designs. For example, as shown in FIGS. 2A and 2B, the finial 23 is of a different design from the finial 13 shown in FIG. 1. Moreover, the color of the transparent finial can come in diverse colors. By changing the finial design or color, the user has a very wide selection of ornamentation available to coordinate with the decoration of a particular space, and the user can change finial designs and color to suit a whim or a season. The connecting end 17 of the finial 13 attaches to a socket 18 at the end of the cartridge 20. There are many ways to attach the finial 13 to the socket 18. For example, the connecting end 17 of the finial 13 could be a threaded male cylinder and the socket 18 a complimentary female threaded bore. Or, as shown in FIG. 1, the socket 18 could have a pair of radially extending posts and the connecting end 17 of the finial 13 a complimentary pair of ramped slots, forming a quarter-turn fastening, as indicated by the arrows at 25. Or, the connecting end 17 of the finial 13 could form an annular groove and the socket 18 could have one or more set screws to hold the finial 13 in place. Persons of ordinary skill in the art will appreciate that there are many arrangements that could be employed to hold the finial 13 in place while making it simple and easy to remove and replace. The socket 18 has an LED light 14. The LED light 14 can be, for example a 0.1 W LED bulb. Alternatively, the light 14 can be an LED, or even multiple LEDs, capable of providing different colors and brightnesses. Adjacent the socket 18, and electrically connected to the LED light 14, is a space in the cartridge 20 for batteries 15. Conventional curtain rods are often cylindrical, thereby providing a suitable space inside the cylindrical rod for cartridge 20. However, other curtain rod shapes also provide interior space for differently-shaped cartridges and batteries. Preferably, the batteries 15 are No. 7 3.6V rechargeable lithium micro batteries. Under the very small power drain of an LED bulb, these batteries will last for substantial periods of time. Moreover, these batteries can be recharged, further increasing their useful life. Unlike conventional incandescent light bulbs, an LED light source has a very long life span. As a result of the very long life span of LED lights and their very low power consumption, the LED illuminated curtain rod finial disclosed by the present invention will provide illumination for very long periods of time.

The batteries 15 are electrically connected to the LED light 14 through an automatic light sensitive switch 16. The automatic light sensitive switch 16 can turn the LED light 14 on when surrounding light dims and can turn it off when surrounding light increases. An light sensitive automatic switch 16 can be directed toward the window, so that it will react to natural sunlight, thereby turning the LED light 14 on at night and off during the day. Or, the light sensitive automatic switch 16 can be directed toward the interior of the room, so that the automatic switch will respond to the light in the room, thereby turning the LED light 14 on when the room's lighting is low and off when it is high and the illumination of the LED light 14 cannot easily be discerned. In a preferred embodiment, a light sensitive automatic switch 16 is adjustable to the amount of light. In yet another preferred embodiment, the light sensitive automatic switch 16 also has a manual remote controlled on/off switch 19, so that the user can turn the LED light 14 off or on, thereby bypassing the automatic switch 16. A remote control 22 can have an on/off button 31 to generate a wireless signal 24 to activate the manual switch 19. As shown in FIG. 1, the signal 24 has a path 26 to the manual remote controlled switch 19. The remote control 22 may also be connected to the light circuitry by a wire. In a preferred embodiment, the remote control 22 can also have a switch 32, or multiple switches, to change the color or brightness of the LED light 14.

As noted above, FIG. 1 shows a symmetrical arrangement of lighted finial. A left LED illuminated finial cartridge 20′ connects to the left curtain rod 11′. The left LED light 14′ is powered by batteries 15′. The left set of batteries 15′ is electrically connected to the left LED light 14′ through an automatic light sensitive switch 16′, which operates as described above. Also part of the left cartridge 20′ is a manual remote controlled switch 19′ which responds to the signals 24 from the remote control 22. In an alternative embodiment, both the right and left LED lights, 14 and 14′, can be powered from one set of batteries, rather than from separate cartridges, and, rather than having separate light sensitive switches at each end, 16 and 16′, and separate remote controlled switches, 19 and 19′, a single automatic switch and a single remote controlled switch can control both LED lights, 14 and 14′. In such an arrangement, electrical wire (not shown) running from the automatic switch 16 and remote controlled switch 19 at the right end of the curtain rod 11 to the left LED light 13′ would control both the left and right LED lights, 13 and 13′.

FIGS. 2A through 2C shows how the cartridge 20 is removed from the end 27 of the curtain rod 11, thereby exposing the port 29 for the batteries 15. The cartridge 20 is secured in the curtain rod end 27 by the friction surface 12, but the cartridge 20 can be easily pulled out, exposing the battery port 29. The port 29 is opened and the old batteries can be removed and new batteries inserted, as shown. Then, the cartridge 20 is re-inserted into the curtain rod 11, to complete the LED illuminated curtain rod finial system 10.

The drawings and description set forth here represent only some embodiments of the invention. After considering these, skilled persons will understand that there are many ways to make a battery-powered, LED-lighted, changeable ornamental finial according to the principles disclosed. The inventors contemplate that the use of alternative structures, materials, or manufacturing techniques, which result in a battery-powered, LED-lighted, changeable ornamental finial according to the principles disclosed, will be within the scope of the invention.

I claim:

1. An LED illuminated curtain rod finial comprising:
a curtain rod having an open curtain rod end,
an LED finial cartridge comprising a body sized to be received within said curtain rod, said body further comprising a finial end and an opposite insertion end, said insertion end received by said open curtain rod end, the finial end of said cartridge further comprising a finial socket, said cartridge further comprising an LED light source located at said finial end, and said cartridge body further comprising at least one battery electrically connected to said LED light source to provide electrical power to said LED light source,
an automatic light sensitive switch electrically interposed between said battery and said LED light source, wherein said light sensitive switch controls the electrical power supplied from said battery to said LED light source in response to a predetermined lighting condition, and
a decorative finial releasably attached to the finial end of said cartridge and covering said LED light source, said decorative finial having at least some portion through which light from said LED light source may pass.

2. The LED illuminated curtain rod finial of claim 1 further comprising a manual light switch interposed between said battery and said LED light source, wherein said manual light switch controls the electrical power supplied from said battery to said LED light source.

3. The LED illuminated curtain rod finial of claim 2 further comprising a remote control device, said remote control device controlling the electrical power allowed by the manual light switch from said battery to said LED light source.

4. The LED illuminated curtain rod finial of claim 2, wherein the remote control device generates a wireless signal to control the manual light switch wirelessly.

5. The LED illuminated curtain rod finial of claim 1, wherein the LED light source further comprises a multi-color LED light source capable of providing more than one color of light.

6. The LED illuminated curtain rod finial of claim 5, wherein multi-color light source changes the color of light in response to an electrical signal from a remote controlled manual light switch interposed between said battery and said LED light source, and said LED illuminated curtain rod finial further comprising a remote control device, wherein said remote control device controls the multi-color light allowed by the manual light switch.

7. An LED illuminated curtain rod changeable finial system comprising:
a curtain rod having left and right ends,
a finial socket at each of said left and right ends,
an LED light located at each of the finial sockets,
at least one battery located within said curtain rod, wherein the battery is electrically connected to at least one of the LED lights to provide electrical power to said one of the LED lights,
an automatic switch sensitive to ambient light, said automatic switch having circuitry electrically interposed between said battery and said one of the LED lights electrically connected to the battery, wherein said switch turns on and off power from said battery to said one of the LED lights electrically connected to the battery in response to a predetermined condition of said ambient light, and
Left and right ornamental finials changeably attached to said finial sockets, wherein at least one of said finials allows at least some light from said one of the LED lights electrically connected to the battery to illuminate said finial.

8. The LED illuminated curtain rod decorative finial system of claim 7 further comprising a remotely controlled manual light switch interposed between said battery and said one of the LED lights electrically connected to the battery, wherein said manual light switch controls the electrical power supplied from said battery to said one of the LED lights electrically connected to the battery in response to a wireless signal from a remote control device.

9. The LED illuminated curtain rod decorative finial system of claim 8, wherein at least one of the LED lights comprises one or more LED lights capable of providing more than one color of light, wherein a selection of the more than one color of light is controlled by said remotely controlled manual light switch, and wherein the selection of the more than one color of light by the manual light switch is in response to a second wireless signal from said remote control device.

10. The LED illuminated curtain rod decorative finial system of claim 7 wherein the curtain rod is formed of left and right curtain rod sections, and wherein the left and right curtain rod sections can be moved with respect to each other to adjust the length of said curtain rod.

11. The LED illuminated curtain rod decorative finial system of claim 7 wherein at least one of the finial sockets at each of said left and right ends of the curtain rod is formed as part of an LED finial unit, and wherein said LED finial unit is releasably held at the one of said left or right ends of the curtain rod, and wherein the battery is held by said LED finial unit.
